(19) United States
(12) Patent Application Publication
(10) Pub. No.: US 2013/0133865 A1
(43) Pub. Date: May 30, 2013

(54) Synthetic Jet Ejector With Selectable Audio Footprint

(71) Applicant: NUVENTIX, INC., Austin, TX (US)

(72) Inventors: Raghavendran Mahalingam, Austin, TX (US); Lee M. Jones, Austin, TX (US); Michael D. Wilcox, Livermore, CA (US); Matthew B. Ernst, Union Grove, WI (US); Brad S. Bringhurst, Austin, TX (US); Stephen P. Darbin, Austin, TX (US)

(73) Assignee: NUVENTIX, INC., Austin, TX (US)

(21) Appl. No.: 13/691,700

(22) Filed: Nov. 30, 2012

Related U.S. Application Data
(60) Provisional application No. 61/564,930, filed on Nov. 30, 2011.

(51) Int. Cl. F28F 13/10; B05B 17/06

(52) U.S. Cl. CPC F28F 13/10; B05B 17/0615
USPC 165/104.34; 165/138; 239/102.1

(57) ABSTRACT

A thermal management system is provided which includes a synthetic jet ejector (203) equipped with a diaphragm (207) and an actuator (209), and a controller (213) which is in electrical communication with the synthetic jet ejector and which causes the actuator to vibrate the diaphragm so as to simultaneously cause the synthetic jet ejector to generate a synthetic jet (205), and to play an audio file stored in a memory device (211).

### CROSS-REFERENCE TO RELATED APPLICATION

This application claims the benefit of priority from U.S. provisional application number 61/564,930, filed Nov. 30, 2011, having the same title, and having the same inventors, and which is incorporated herein by reference in its entirety.

### FIELD OF THE DISCLOSURE

The present disclosure relates generally to synthetic jet ejectors, and more particularly to systems and methods for producing a desired audio footprint with synthetic jet ejectors.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System”; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is an illustration of a particular, non-limiting embodiment of a thermal management system in accordance with the teachings herein.

FIG. 3 is a flowchart of a particular, non-limiting embodiment of a method for implementing thermal management in accordance with the teachings herein.

### SUMMARY OF THE DISCLOSURE

In one aspect, a thermal management system is provided which comprises (a) a synthetic jet ejector comprising a diaphragm and an actuator; and (b) a controller which is in electrical communication with said synthetic jet ejector and which causes said actuator to vibrate said diaphragm so as to simultaneously cause said synthetic jet ejector to generate a synthetic jet, and play an audio file recorded in said memory device.

In another aspect, a method for providing thermal management for a heat source is provided which comprises (a) providing a synthetic jet ejector comprising a diaphragm and an actuator; (b) causing said actuator to vibrate said diaphragm so as to simultaneously cause said synthetic jet ejector to generate a synthetic jet and to play an audio file; and (c) using the synthetic jet to thermally manage the heat source.

### DETAILED DESCRIPTION

Noise suppression is a common problem with synthetic jet ejector applications. In particular, significant effort has been expended in developing synthetic jet ejectors which operate more quietly, so that objectionable noises will not be produced during their operation. In some cases, achieving such noise suppression may require compromises, such as operating the synthetic jet ejector at other than optimal frequencies from a power consumption or heat dissipation standpoint. Accordingly, there remains a need in the art for new systems and methods for dealing with the acoustical footprint of synthetic jet ejectors.

It has now been found that this need may be met in some applications by tuning the noise produced by synthetic jet ejectors so that it is no longer objectionable, rather than by attempting to eliminate such noise. In particular, acoustical synthetic jet ejectors are essentially speakers, and hence have the ability, unique among thermal management devices, to produce (or reproduce) a wide variety of high fidelity noises. This ability may be tapped so that, rather than eliminating or minimizing the noises produced by the synthetic jet ejector, the acoustical footprint is modified so that the noise produced is not objectionable. This may be accomplished, for example, by causing the synthetic jet ejector to essentially “play” a sound file of one or more recorded, desirable noises, such as sounds of nature or music, or to reproduce a desirable sound or otherwise operate in a manner that produces a desirable sound. In some applications, this approach may be utilized to convert synthetic jet ejectors from mere utilitarian devices used for thermal management to devices which create a mood or enhance a setting.

The systems, devices and methodologies disclosed herein utilize synthetic jet actuators or synthetic jet ejectors. Prior to describing these systems, devices and methodologies, a brief explanation of a typical synthetic jet ejector, and the manner in which it operates to create a synthetic jet, may be useful.

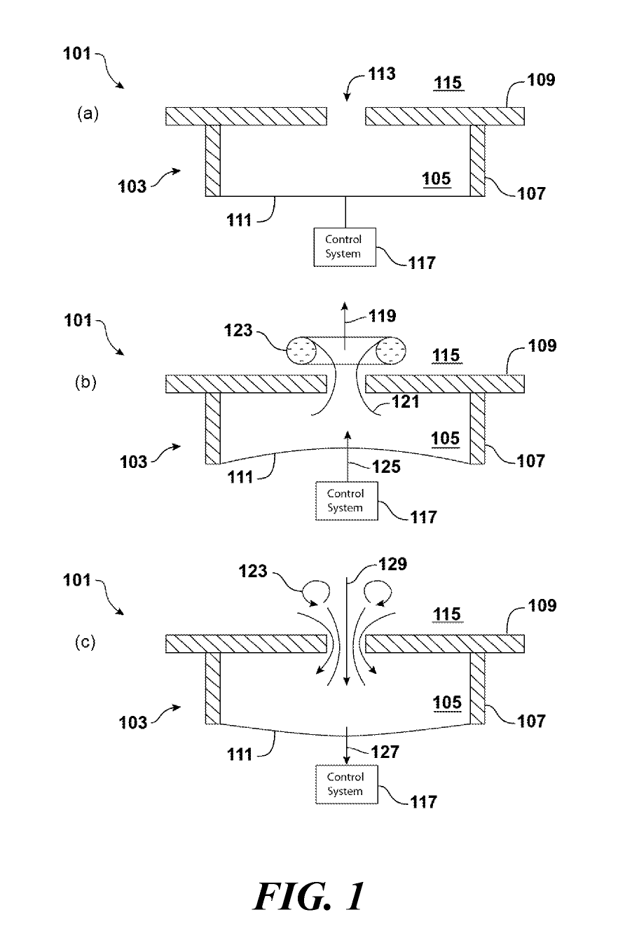

FIG. 1 illustrates the operation of a typical synthetic jet ejector in forming a synthetic jet. As seen therein, the synthetic jet ejector 101 comprises a housing 103 which defines and encloses an internal chamber 105. The housing 103 and chamber 105 may take virtually any geometric configuration, but for purposes of discussion and understanding, the housing 103 is shown in cross-section in FIG. 1 to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein which may be of various geometric shapes. The orifice 113 diametrically opposes the rear diaphragm 111 and fluidically connects the internal chamber 105 to an external environment having ambient fluid 115.

The movement of the flexible diaphragm 111 may be achieved with a voice coil or other suitable actuator, and may be controlled by a suitable control system 117. The diaphragm 111 may also be equipped with a metal layer, and a metal electrode may be disposed adjacent to, but spaced apart from, the metal layer so that the diaphragm 111 can be moved via an electrical bias imposed between the electrode and the metal layer. Moreover, the generation of the electrical bias can be controlled by any suitable device including, but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 will now be described with reference to FIGS. 1b-1c. FIG. 1b depicts the synthetic jet ejector 101 as the diaphragm 111 is controlled to move inward into the chamber 105, as depicted by arrow 125. The inward motion of the diaphragm 111 reduces the volume of the chamber 105, thus causing fluid to be ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The outward motion of the diaphragm 111 causes the volume of chamber 105 to increase, thus drawing ambient fluid 115 into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

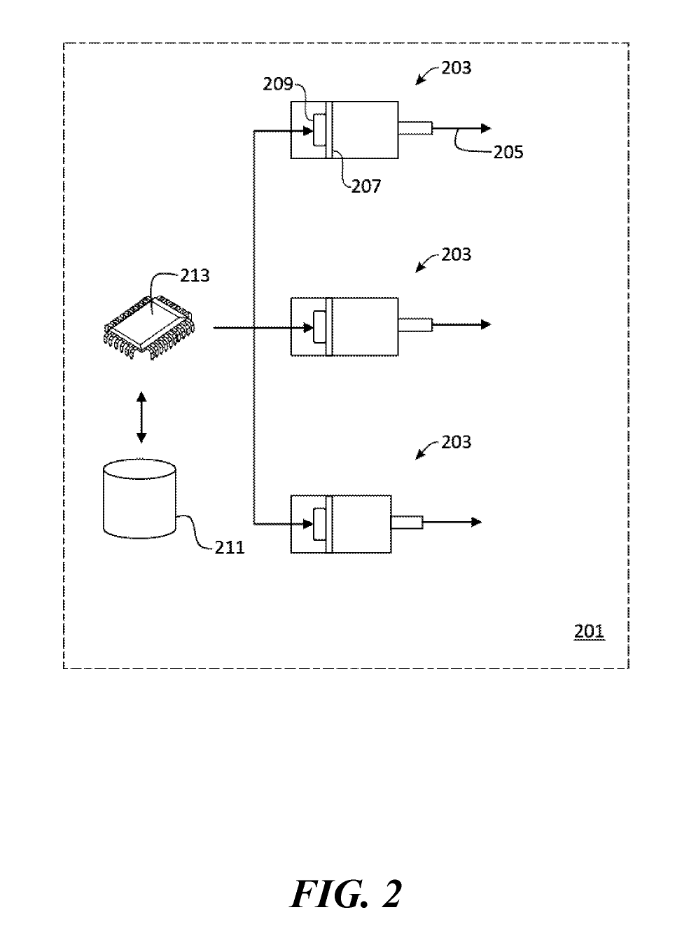

FIG. 2 illustrates a first particular, non-limiting embodiment of a device in accordance with the teachings herein. As seen therein, the device 201 in this particular embodiment comprises one or more synthetic jet ejectors 203, each of which generates one or more synthetic jets 205 that may be used to cool a heat source. The synthetic jet ejectors 203 may be, for example, any of the synthetic jet ejectors disclosed in the references cited in the background section, each of which is incorporated herein by reference in its entirety. Typically, each of the synthetic jet ejectors comprises at least one diaphragm 207 which is driven or controlled by an actuator 209.

The device 201 further comprises one or more memory devices 211 which, individually or in the aggregate, have one or more audio files stored therein, and a controller 213 which controls the operation of each synthetic jet ejector 203, preferably by controlling the frequency with which the diaphragm 207 of the synthetic jet ejector 203 oscillates or vibrates. The controller 213 is preferably in communication with the one or more memory devices 211 and with each synthetic jet ejector 203, and more preferably is in electrical communication with these devices.

The controller 213 contains suitable circuitry and/or programming instructions to allow it to “play” audio files stored in the one or more memory devices 211, much as a controller in a stereo system causes the speakers of the system to audibly reproduce an audio recording.

It will be appreciated that the controller 213 may control each of the synthetic jet ejectors 203 in the same or in a different manner. For example, the synthetic jet ejectors 203 may be controlled in a manner similar to the speakers in a stereo system, such that each synthetic jet ejector 203 reproduces part of the sound recorded in the audio file, and such that the synthetic jet ejectors 203 work in concert to impart such audio effects as stereophonic sound, or to create a more faithful reproduction of the sound recorded in the audio file. Moreover, while the particular embodiment depicted shows a single controller 213 controlling a plurality of synthetic jet ejectors 203, it will be appreciated that, in some embodiments, each synthetic jet ejector 203 may be controlled by a dedicated controller 213 which may work independently of, or in concert with, the other controllers 213. Moreover, some embodiments may include only a single synthetic jet ejector 203.

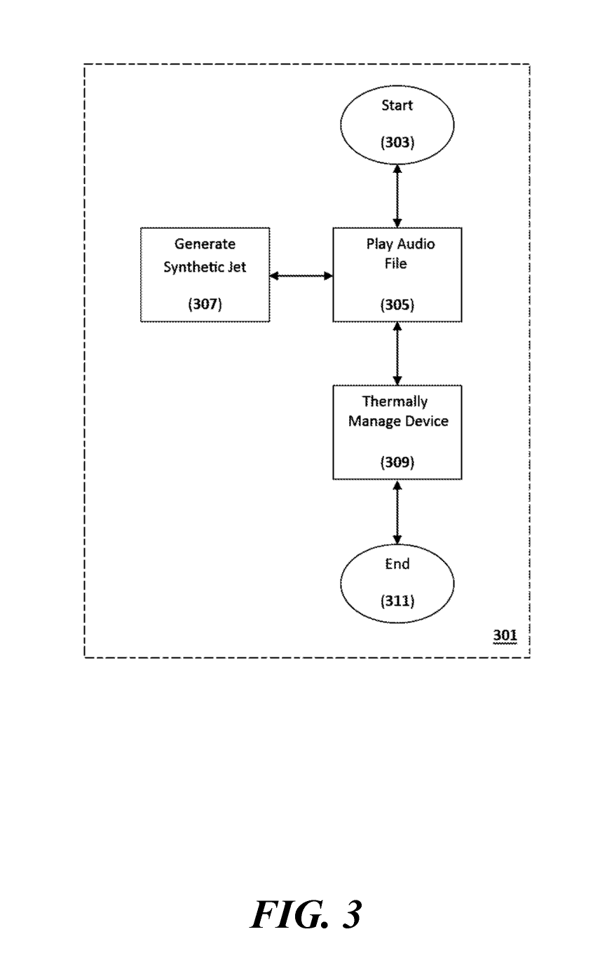

FIG. 3 depicts a first particular, non-limiting embodiment of a methodology in accordance with the teachings herein. As seen therein, after the method 301 begins 303, an audio file is played 305 by a synthetic jet ejector. While the audio file is played, the synthetic jet ejector also generates 307 one or more synthetic jets which are used to thermally manage a device or heat source 309. The method then ends 311.

The systems and methodologies disclosed herein may be leveraged in a variety of applications. For example, these systems and methodologies may be utilized in the thermal management systems in the isles of commercial buildings or stores such as, for example, supermarkets. In this application, these thermal management systems may be simultaneously utilized for both thermal management and, for example, to play audio files for targeted product marketing. The systems and methodologies disclosed herein may also be utilized in emergency lighting applications, such as in exit signs, where they may be leveraged, in addition to their thermal management function, to play emergency warnings, instructions or alerts, to provide audio cues for the blind, or to perform other such functions.

The systems and methodologies disclosed herein may also be utilized in a variety of troubleshooting applications. For example, these systems may be utilized to thermally manage troubleshooting lights, while also providing audio diagnostics or signals.

The systems and methodologies disclosed herein may be further utilized in audio systems integrated with LED lighting. In such applications, the systems may be utilized, for example, to provide thermal management of the LED lightning, while also playing audio files. Such audio files may include, for example, sounds of nature, music, soothing background noises, or other such sounds to create an ambiance or enhance an environment.

The systems and methodologies disclosed herein may further be utilized in a variety of gaming applications. In such applications, they may be utilized, for example, to produce some or all of the sounds associated with a game, while concurrently providing thermal management to video chips and other heat sources. In some variations of such embodiments, these systems may be utilized instead to provide sounds that are easily camouflaged by, or are otherwise not discernible over, the sounds associated with the gaming application.

The systems and methodologies disclosed herein may utilize various types of memory for the storage of audio files and audio tracks that may be played by a synthetic jet ejector, and this memory may be volatile or non-volatile memory. Possible non-volatile memory types which may be utilized in these systems and methodologies include flash memory and erasable programmable read-only memory (EPROM). Suitable EPROM may include electrically erasable programmable read-only memory (EEPROM). Suitable flash memory may include NAND type or NOR type flash memory.

The memory may be random access memory (RAM) such as, for example, static random access memory (SRAM) and dynamic random access memory (DRAM). Examples of DRAM which may be utilized in the systems and methodologies disclosed herein include double data rate synchronous dynamic random access memory (DDR SDRAM), thyristor RAM (T-RAM), zero-capacitor RAM (Z-RAM) and twin transistor RAM (TTRAM). The memory may also be read-only memory (ROM) such as, for example, programmable read-only memory (PROM) and field programmable read-only memory (FPROM). The memory may be implemented in various form factors, including, for example, as memory cards, flash drives, disk drives or solid state drives. Of course, it will be appreciated that devices made in accordance with the teachings herein may include more than one type of memory in more than one form factor.

The memory may be associated with, or may be part of, a thermal management system which includes the synthetic jet ejectors. Alternatively, the memory may be part of a host device. For example, the memory could be part of a host computer that incorporates the synthetic jet ejector and controller as part of a thermal management system. Such a computer could be, for example, a desktop, laptop or tablet PC, or could be a mobile technology platform such as a smartphone, personal digital assistant (PDA) or e-book reader.

Similarly, the controller could also be part of the host device. Thus, for example, the controller may be a central processing unit (CPU), a card (including, for example, a video card associated with a display in the host device or an add-on card), a bus, or an accessory associated with any of the foregoing devices. As a specific example, the controller may be part of a device which connects to a suitable port (such as, for example, a USB port). In the foregoing embodiments, the device may be provided with suitable software that accesses audio tracks stored on or by the host device, such as an iTunes™ library or other library of music or audio files, and which plays such tracks or selections (and possibly a subset of such tracks or selects which is designed by the user) during its operation.

Various actuators may be utilized in the devices and methodologies described herein. Preferably, these actuators include a voice coil and a magnet, either of which may be attached directly or indirectly to the diaphragm. However, in some embodiments, the actuators may include one or more piezoelectric materials which may be, for example, piezoelectric ceramics.

The audio files utilized in the devices and methodologies disclosed herein for storing audio data may have various formats, and the data stored therein may be in a compressed or uncompressed state. If compression is utilized, the compression may be lossless or lossy. In some embodiments, the audio data may be in the form of a raw bitstream, but is preferably in a container format or audio data format having a defined storage layer. More particularly, the audio data may be stored in an uncompressed format such as, for example, WAV, AIFF, AU or raw headerless PCM; in a compressed, lossless format such as, for example, FLAC (Free Lossless Audio Codec), WavPack, Monkey's Audio, or ALAC (Apple Lossless); or in a compressed, lossy format such as, for example, MP3 (MPEG-1 or MPEG-2 Audio Layer III), Vorbis, Musepack, AAC (Advanced Audio Coding), ATRAC (Adaptic Transform Acoustic Coding), or WMA lossy (Windows Media Audio lossy).

As previously noted, in some embodiments, two or more synthetic jet ejectors may operate in conjunction to play an audio file. Thus, for example, the synthetic jet ejectors may operate in conjunction to produce stereophonic sound, which creates the illusion of directionality and audio perspective. Such stereophonic sound may include, for example, quadraphonic sound or surround sound.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for providing thermal management for a heat source, comprising:
providing a synthetic jet ejector equipped with a diaphragm and an actuator;
causing said actuator to vibrate said diaphragm so as to (a) play an audio file, and (b) produce a synthetic jet while the audio file is being played; and
using the synthetic jet to thermally manage the heat source.

2. The method of claim 1, wherein the heat source is in thermal communication with a heat sink, and further comprising:
directing the synthetic jet onto, or adjacent to, a surface of said heat sink.

3. The method of claim 2, wherein the heat sink is equipped with a plurality of heat fins and a plurality of channels, wherein each of said plurality of channels is formed by the space between a pair of adjacent heat fins, and wherein directing the synthetic jet onto, or adjacent to, a surface of said heat sink includes directing the synthetic jet into one of said plurality of channels.

4. The method of claim 1, wherein the audio file is stored in a memory device.

5. The method of claim 4, wherein the memory device is a non-volatile memory device.

6. The method of claim 4, wherein the memory device is selected from the group consisting of flash memory devices and erasable programmable read-only memory.

7. The method of claim 1, wherein said diaphragm vibrates at a frequency which is adjustably controlled by a controller, and wherein said controller causes said actuator to vibrate said diaphragm so as to play the audio file.

8. The method of claim 7, wherein said synthetic jet ejector is part of a thermal management system for a host device, wherein said host device is a computer, and wherein said controller is a CPU in said host device.

9. The method of claim 8, wherein said audio file is stored in a music library associated with the host device.

10. The method of claim 7, wherein said synthetic jet ejector is part of a thermal management system for a host device, wherein said host device is a mobile technology platform, and wherein said controller is a CPU in said host device.

11. The method of claim 10, wherein said audio file is stored in a music library associated with the host device.

12. The method of claim 7, wherein said synthetic jet ejector is part of a thermal management system for a host device, and wherein said controller is a dedicated controller for said thermal management system.

13. The method of claim 4, wherein the controller is in electrical communication with the synthetic jet ejector, and wherein the controller is also in electrical communication with the memory device.

14. The method of claim 1, further comprising:
playing said audio file as part of a targeted advertisement campaign.

15. The method of claim 1, wherein said synthetic jet ejector is disposed in a host device, and further comprising:
playing the audio file as part of an audio diagnostic for said host device.

16. The method of claim 1, wherein said synthetic jet ejector is disposed in a host gaming device, and further comprising:
playing the audio file to produce at least part of the sounds associated with a game played on the gaming device.

17. A device, comprising:
a synthetic jet ejector comprising an oscillating diaphragm which is driven by an actuator;
a memory device; and
a controller which controls the frequency at which said diaphragm oscillates; wherein said controller causes said diaphragm to oscillate so as to (a) play an audio file recorded in said memory device, and (b) produce a synthetic jet while the audio file is being played.

18. The device of claim 17, further comprising a plurality of synthetic jet ejectors, each comprising a diaphragm and an actuator, and wherein said controller is in electrical communication with each of said synthetic jet ejectors.

19. The device of claim 18, wherein said controller causes each of said actuators associated with a synthetic jet ejector to vibrate the diaphragm of the synthetic jet ejector so as to simultaneously cause said synthetic jet ejector to generate a synthetic jet, and to play an audio file.

20. The device of claim 17, wherein said thermal management system is disposed in an LED lighting system.
